(19) United States
(12) Patent Application Publication
(10) Pub. No.: US 2025/0350802 A1
(43) Pub. Date: Nov. 13, 2025

(54) SYSTEMS AND METHODS FOR GENERATING MEMBERSHIPS RECOMMENDATIONS USING MACHINE LEARNING

(71) Applicant: Google LLC, Mountain View, CA (US)

(72) Inventors: Martin Krivánek, Thalwil (CH); Alex Kiraly, Mountain View, CA (US); Andrew Sofer, Walnut Creek, CA (US); Briana Yvonne Seiderman, Zurich (CH); Silviu Bota, Horgen (CH); Shu Li, Zurich (CH)

(21) Appl. No.: 19/203,662

(22) Filed: May 9, 2025

Related U.S. Application Data
(60) Provisional application No. 63/645,812, filed on May 10, 2024.

(51) Int. Cl. H04N 21/466; H04N 21/266; H04N 21/4784

(52) U.S. Cl. CPC H04N 21/4668; H04N 21/266; H04N 21/4784

(57) ABSTRACT

A method includes identifying a plurality of channel owners, each channel owner associated with a respective channel of a set of channels of a content sharing platform. For each respective channel, using one or more artificial intelligence (AI) models, a first and second value is determined, each indicating a respective number of projected members subscribing to a respective channel. For each respective channel, based on the respective first and second value, a set of actions to be performed by the respective channel owner for enabling the set of membership tiers is determined. For each channel owner, one or more rewards for performing at least a subset of the set of actions is determined. A recommendation is generated that reflects the one or more rewards and the subset of the actions. A respective indicator referencing the recommendation is provided for presentation to each of the plurality of channel owners.

### RELATED APPLICATION

This application claims the benefit of U.S. Provisional Application No. 63/645,812, filed May 10, 2024, the entire content of which is hereby incorporated by reference.

### TECHNICAL FIELD

The disclosed implementations relate to methods and systems for generating memberships recommendations using machine learning.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes identifying a plurality of channel owners, each channel owner associated with a respective channel of a set of channels of a content sharing platform. For each respective channel, using one or more artificial intelligence (AI) models, a first value indicating a first number of projected members subscribing to a respective channel with an enabled set of membership tiers is determined and a second value indicating a second number of projected members subscribing to the respective channel with the enabled set of membership tiers is determined. for each respective channel, based on the respective first value and the respective second value, a set of actions to be performed by the respective channel owner of the plurality of channel owners for enabling the set of membership tiers is determined. For each channel owner of the plurality of channel owners, one or more rewards for performing at least a subset of the set of actions is determined. A recommendation is generated that reflects the one or more rewards and the subset of the actions. A respective indicator referencing the recommendation is provided for presentation to each of the plurality of channel owners.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 is an illustration of an example graphical user interface (GUI) showing an incentives recommendation on a channel owner's channel, in accordance with implementations of the disclosure.

FIG. 3 depicts a flow diagram of an example method for training an earnings machine learning model to generate personalized data related to membership tiers, in accordance with implementations of the present disclosure, in accordance with implementations of the disclosure.

FIG. 3 depicts a flow diagram of an example method for training an AI model to predict the number of new members a channel is expected to obtain within a predetermined timeframe after enabling subscription services, in accordance with implementations of the disclosure.

FIG. 4 depicts a flow diagram of an example method for training an AI model to predict a growth trajectory of new members, in accordance with implementations of the disclosure.

FIG. 5is a flow diagram of an example method for generating an incentives recommendation using AI model(s), in accordance with implementations of the disclosure.

FIG. 6is a flow diagram of an example method for generating an incentives recommendation for channel that already enabled a membership tier, in accordance with implementations of the present disclosure.

FIG. 7 is a flow diagram of another example method for generating an incentives recommendation for a channel, in accordance with implementations of the present disclosure.

FIG. 8 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users via one or more personal channels (“channels”). A channel can be data content available from a common source or data content having a common topic, theme, or substance. The channel can serve as a homepage for the channel owner's account and include media items having a common topic, theme, or substance. The media items can be chosen, made available, and/or uploaded by the channel owner to the channel. The channel owner can further customize their channel(s) by selecting a background and color scheme, controlling some of the information that appears on the channel, etc.

Channel owners can enable certain content-related features to monetize their channel(s). For example, content creators can realize earnings from advertisements (“ads”) that would appear during certain segments of certain media items, receive revenue from viewers via a gratuity feature, sell merchandise, etc. In some instances, channel owners can generate revenue by enabling channel memberships that offer viewers (e.g., users of the content sharing platform) one or more particular tiers of content access (referred to as a “membership tier”). A membership tier is a feature of the content sharing platform that allows “members” to join a channel through monthly fees and receive members-only benefits referred to as privileges. Each membership tier can have different privileges such as access to exclusive content (content not made available to non-members), badges, emojis, access to live-streams, chats and other bonus content that only members can access. In some instances, a particular channel can include multiple membership tiers, where each level can include different privileges for a different monthly fee.

In certain instances, channel owners may fail to see the value in enabling channel memberships, thus causing themselves and the content sharing platform to miss out on potential revenue. Alternatively, while some channel owners may enable channel memberships, they do not adequately promote their membership tiers, thus failing to realize any significant benefit from the channel memberships.

A content sharing platform can generate recommendations to channel owners advising them to enable certain content-related features. For example, a content sharing platform can recommend channel owners to provide particular levels of content access. However, these recommendations are generally broadly targeted, fail to convey the beneficial impact of these features, and channel owners can receive multiple recommendations on a periodic basis. As such, many channel owners typically ignore these recommendations because they fail to see the value in them, while some channel owners that do adopt the recommendations fail to realize any significant benefit. As a result, computing resources consumed by content sharing platforms in generating recommendations to a disinterested group of users are aimlessly expended. Specifically, content sharing platforms may unnecessarily consume computing resources by generating, transmitting, storing, and presenting recommendations that are not optimized for user engagement. Furthermore, channel owners who provide membership tiers but fail to adequately promote them cause the content sharing platform to consume processing cycles, memory bandwidth, and storage used to support certain features related to the membership tiers, thereby reducing overall system efficiency and increasing computational overhead.

Aspects and implementations of the present disclosure address the above and other deficiencies by providing a system for generating, for specific channel owners, personalized incentives (e.g., rewards such as monetary rewards) that channel owners can collect for completing certain actions (e.g., satisfying conditions) related to their respective channels. Each incentive can include a particular reward for satisfying a condition. For example, channel owners can receive a first reward for launching a membership tier for a specific time (e.g., for a year), a second reward for each new member that subscribes to the membership tier, a third reward for a certain number of new members subscribing within a specific timeframe, etc.

For certain channel owners or groups of channel owners, the present system can generate an incentives recommendation that lists one or more rewards the channel owner can collect for completing a respective action. The incentives recommendation can be in the form of a pop-up message on a channel's user interface, an email message, etc. In an illustrative example, an incentives recommendation can include a message to the channel owner which indicates that the channel owner can obtain $1,000 for the launch of a membership tier, $10 per new member that subscribes to the membership tier, and a $2,000 payment for obtaining 100new members by a certain date.

In order to generate the incentives recommendations, one or more artificial intelligence (AI) models can be employed to determine the number of new members projected to subscribe to a channel membership in a predetermined timeframe provided that the membership tier is offered to viewers. The AI model(s) can be trained using training datasets with certain labeled channel features and/or media item features corresponding to media items on a channel. A channel feature can reflect certain characteristics of the channel, such as viewer activity of the channel, engagement data of the channel, earnings of the channel. A media item feature can reflect certain data related to a media item on the channel (e.g., characteristics data related to the media item, viewer activity data related to the media item, engagement data related to the media item, etc.) In some implementations, the AI model can be trained to learn relationships between certain channel feature(s) (or media item features) of a channel that offers one or more membership tiers and the number of new members that subscribed to the membership tier within a predetermined timeframe.

The trained AI model(s) can then receive, as input, channel features (and/or media item features) of a particular channel and generate, as output, one or more values reflecting one or more predicted number of new members that are projected to subscribe to an offered membership tier within a certain timeframe. In an illustrative example, a first AI model can predict the number of new members a channel owner would obtain within a predetermined timeframe after enabling channel memberships (e.g., 30 days after offering a membership tier) while a second AI model can estimate a growth trajectory of new members based on the predicted new members data obtained from the first AI model. A recommendation engine can determine the projected revenue (of the content sharing platform) expected to be derived from the new members (determined from either or both of the AI models), and, using the projected revenue prediction, determine the incentives to offer the channel owner. The value of the one or more incentives can be determined using a formula, an algorithm, another AI model, etc. The recommendation engine can send the incentives recommendation indicating the one or more incentives to the channel owner. By encouraging the channel owners to offer membership tiers, both the channel owners and the content sharing platform can earn additional revenue from viewers.

Aspects of the present disclosure result in improved performance of recommendation tools. In particular, the aspects of the present disclosure enable generating personalized and targeted incentives recommendations for respective target channels. As a result, the recommendations specifically target particular channel owners, incentivize the channel owner to provide one or more membership tiers to their viewers, and improve the conversion rate of dispatched recommendations. In addition, by generating personalized and targeted incentives recommendations, considerable time and computing resources aimlessly expended by conventional content sharing platforms are saved. In particular, system resources are efficiently consumed by generating, transmitting, storing and presenting membership configurations that are optimized for user engagement. In particular, processing cycles, memory bandwidth, and storage are used to support membership configurations that align with subscriber behavior, thereby increasing overall system efficiency and increasing computational overhead.

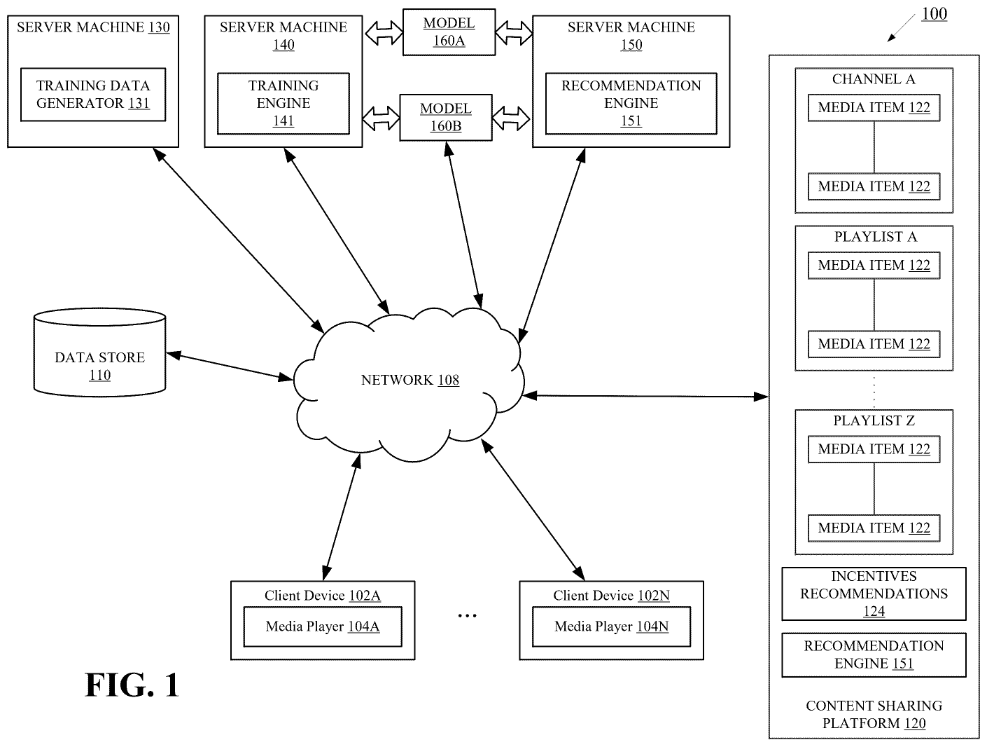

FIG. 1 illustrates an example system architecture 100, in accordance with implementations of the present disclosure. The system architecture 100 (also referred to as “system” herein) includes client devices 102A-102N, data store 110, content sharing platform 120, and/or server machines 130, 140, 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machines 130, 140, 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server. Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120.

In some implementations, content sharing platform 120 and server machines 130, 140, 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102Z. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or and identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF 89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, the channel owner can enable channel memberships that provide one or more membership tiers on a channel. Each membership tier can allow “members” to join the channel through monthly fees and receive privileges (e.g., members-only benefits) that can include access to exclusive content, badges, emojis, access to live-streams, chats, etc. In some implementations, a particular channel can offer multiple membership tiers, where each level can include different privileges for a different monthly fee.

In some implementations, content sharing platform 120 (and/or server machine 150) can include recommendation engine 151 that can generate incentives recommendations 124 to one or more users (e.g., channel owners) of content sharing platform 120. An incentives recommendation 124 can be an indicator (e.g., interface component such as, for example, a popup message, electronic message, recommendation feed, etc.) that provides a channel owner with personalized data related to enabling (e.g., activating) a channel membership that offers viewers paid access to one or more membership tiers on a particular channel. In some implementations, an incentives recommendation 124 can be indicative of rewards the channel owner will receive when certain actions are performed (and/or certain conditions are met). These actions can include, for example, launching a channel membership, obtaining a new member for the channel membership, maintaining the channel membership for a predetermined period of time, uploading a members-only media item (e.g., video item), providing a members-only livestream, chatting in the livestream, generating a members-only post, adding a special award (e.g., badge, emoji, icon, avatar, etc.), referencing the channel membership during in a media item (e.g., in a video item), etc. Each action can include a respective reward. For example, launching a channel membership can include a monetary reward of $1,000, obtaining new members for a membership tier of the channel membership can include a monetary reward of $10 per member, maintaining the channel membership for thirty days can include a monetary reward of $2,000, etc.

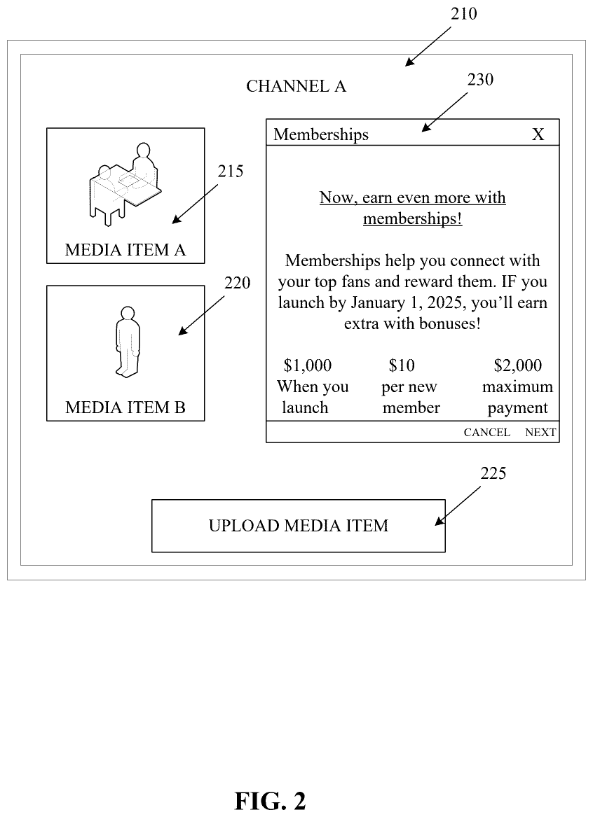

FIG. 2 is an example graphical user interface (GUI) showing an incentives recommendation on a channel owner's channel. In particular, FIG. 2 shows GUI 210 which shows a channel owner's channel (e.g., channel A). Channel A includes two media items (media item A 215 and media item B 220) uploaded to channel A by the channel owner. Button 225 allows the channel owner to upload additional media items. Incentives recommendation 230 is a pop-up window displayed on GUI 210. Incentives recommendation 230 includes a message to the channel owner, that was generated by recommendation engine 151, which indicates that the channel owner can obtain specific monetary rewards (e.g., $1,000 for the launch, $10 per new member, and $2,000 maximum payment for a certain number of new members) if they launch a channel membership (e.g., memberships) by a certain date (e.g., by Jan. 1, 2025).

Returning to FIG. 1, in some implementations, an incentives recommendation 124 can be made using data (referred to as channel features and/or media item features) from a variety of sources including historical and/or current data related to other users, channels, media items, ad earnings received and/or projected ad earnings, membership plans, playlist media items, recently watched media items, media item ratings, information from a cookie(s), user history, regional data, viewer activity, fanship data (e.g., number of likes, number of subscribers, number of shares, etc.) and other sources. In some implementations, a recommendation can be based on output of trained AI models 160A, 160B. In some implementations, the incentives recommendation 124 can be presented on media player 104A-104N (e.g., on the user interface associated with a channel of a channel owner), sent to a different application associated with the channel owner (e.g., sent as an email message to an email address related to the channel creator, sent as a text to a phone number related to the channel creator, etc.) and/or provided to the channel owner using other means. In some implementations, the output can include one or more values reflecting one or more predicted number of new members that are projected to subscribe to an offered membership tier within a certain timeframe.

AI models 160A, 160B can be machine learning models trained to generate output related to incentives recommendation 124. In particular, AI model 160A can be trained (e.g., using training data sets having labeled historic data) to predict the number of new members a channel owner would obtain within a predetermined timeframe after enabling channel memberships (e.g., 30 days after offering a membership tier). In some implementations, AI model 160A can be trained to learn relationships 1) between certain channel feature(s) of a channel before and/or after one or more membership tiers has been enabled and the number of new members obtained during a predetermined time frame after the membership tier(s) were offered.

AI model 160B can be trained to estimate a growth trajectory of new members based on actual or predicted new members data (e.g., the number of new members obtained during a certain timeframe after offering a membership tier). For example, AI model 160B can be trained to predict the number of projected new members, for a particular channel, one year after enabling a membership tier based on the number of new members the channel obtained (or is predicted to obtain via AI model 160A) 30 days after enabling the membership tier. In some implementations, AI models 160A and 160B can be the same AI model. For example, an AI model can be trained to first predict the number of new members a channel owner would obtain within a first predetermined timeframe after enabling channel memberships, then estimate a growth trajectory of new members for a second timeframe.

In some implementations, in order to generate incentives recommendation 124, recommendation engine 151 can use, as input for one or more trained AI models (e.g., AI models 160A, 160B, AI model 160, etc.), the data reflecting channel features and/or media item features of a channel. Recommendation engine 151 can then obtain, as output from the trained AI model(s), 1) data reflecting the number of new members a channel owner would obtain within a predetermined timeframe after enabling channel memberships, and 2) an estimated growth trajectory of new members for a certain timeframe. Recommendation engine 151 can then determine, based on the output data, one or more personalized incentives for the channel owner. In some implementations, recommendation engine 151 can generate the personalized incentives by determining the projected revenue earned from the predicted number of members over one or more time periods, input the projected revenue into an incentives model (e.g., a mathematical formula, another AI model, an algorithm, an expression, etc.) and obtain the one or more personalized incentives. In some implementations, the incentives model can include multiple formulas where each formula correlates a reward to the projected revenue multiplied by a predetermined modifier value (e.g., Rewardlaunch=0.2*projected revenue, RewardMaxPayment=0.3*projected revenue, etc.). In another example, if the recommendation engine 151 determines that the predicted number of members will generate $4,420 one year after enabling channel memberships (e.g., the membership tier costs $10 a month and AI models 160A, 160B determined that month 1 will yield 2 new members, month 2 will yield 3 new members, month 3 will yield 4 members, . . . , month 12 will yield 13 new members), recommendation engine 151 can input the projected revenue into an incentives model that generates an incentives recommendation 124 indicating that the channel owner will receive $10 per new member (thus $900 paid for the projected new members), $1,000 to launch and maintain the membership tier for at least one year, and $2000 for obtaining 90 new members. In some implementations, the total monetary reward of the incentives can be set to equal or be less than a certain percentage of the projected revenue (e.g., 30% or less) to enable the content sharing platform 120 to earn a profit despite paying the monetary rewards.

In some implementations, the incentives can be determined based on one or more revenue criteria. A revenue criterion can be a range of values that are related to a set of monetary rewards. For example, if the projected revenue from the number of predicted members is between a $4,000 and $5,000, then a first set of monetary rewards can be offered to the channel owner (e.g., 1,000 for the launch of a membership tier, $10 per new member that subscribes to the membership tier, and a $2,000 payment for obtaining 100 new members by a certain date), if the projected revenue from the number of predicted members is between a $5,000 and $6,000, then a second set of monetary rewards can be offered to the channel owner (e.g., 1,100 for the launch of a membership tier, $11 per new member that subscribes to the membership tier, and a $2,500 payment for obtaining 100 new members by a certain date), and so forth.

In some implementations, the incentives can be determined based on individual projected revenue values. Specifically, the monetary rewards can be customized based on the projected revenue from the number of predicted members for a membership tier. The individual projected revenue values can be obtained by using the projected revenue or predicted number of members as input into a particular incentives model (e.g., a mathematical formula, another Al model, an algorithm, etc.).

Training data generator 131 (residing at server machine 130) can generate training data to be used to train earnings AI models 160A, 160B (or other AI models). In some implementations, training data generator 131 can generate the training data using one or more channel features and/or media item features. A channel feature can correspond to certain types of data related to a particular channel. In particular, a channel feature can include characteristics data related to the channel, viewer activity data related to the channel, engagement data, monetization settings, activities data, etc. The characteristics data can include descriptive or specific data related to the channel, such as the channel title, the geographic region associated with the channel, viewer demographics (e.g., viewer age, sex, location, etc.), etc. The viewer activity data can relate to metrics data associated with the viewers of the channel, such as, for example, the number of views recorded for the channel, the number of subscribers recorded for the channel, the number of times the channel was shared, watch hours, etc. The engagement data can relate to data pertaining to certain interactions between the viewers and the channel, such as, for example, the number of comments made on the channel's comments section, the number of likes recorded for the channel, etc. Earnings data can include data related to the earnings generated by the channel over a specific time period (e.g., over 7 days, 30 days, 60 days, etc.) by a particular earnings generating feature (e.g., ad earnings). In some implementations, the ad earnings data can relate to the ad earnings generated, by a particular type of advertisement, for one or more media items on a channel (or for the channel itself). In some implementations, the ad earnings can relate to a particular billing model implemented by the channel. For example, the channel can implement a SVOD (Subscription Video on Demand) model, a TVOD (Transactional Video on Demand) model, an AVOD (Advertising-Based Video on Demand and Free Ad-Supported) model, a hybrid earnings model, etc. Monetization settings can include data related to whether particular advertisements are enabled. For example, the monetization settings can relate to whether mid-roll ads are enabled for the entire channel, for a portion of the channel (e.g., for a certain number of media items on the channel), whether pre-roll ads are enabled, whether post-roll ads are enabled, the category of advertisements enabled (e.g., unskippable ads, skippable ads, 5 second ads, 30 second ads, and so forth), etc. The activities data can relate to channel owner activities on the channel, such as, for example, the number of media items added, number of playlists generated, type of content provided (e.g., livestreams, shorts, videos, etc.) etc. In some implementations, the training data can be historical training data (e.g., channel features or media item features that were previously recorded), predicted data, or any combination thereof. Predicated data can be generated using one or more of an AI or neural network model, heuristics, rule-based methods, extrapolation, etc. For example, the training data can include estimated ad revenue per media item which can be determined by obtaining a predicted number of views (per day, per week, etc.) for a media item and multiplying the predicted data by the projected revenue per ad view.

A media item feature can correspond to certain types of data related to a particular media item. In particular, a media item feature can be related to characteristics data related to the media item, viewer activity data related to the media item, engagement data related to the media item, earnings data related to the media item, monetization settings related to the media item, activities data related to the media item, etc. These features can be similar to those described in reference to channel features but related to a particular media item instead.

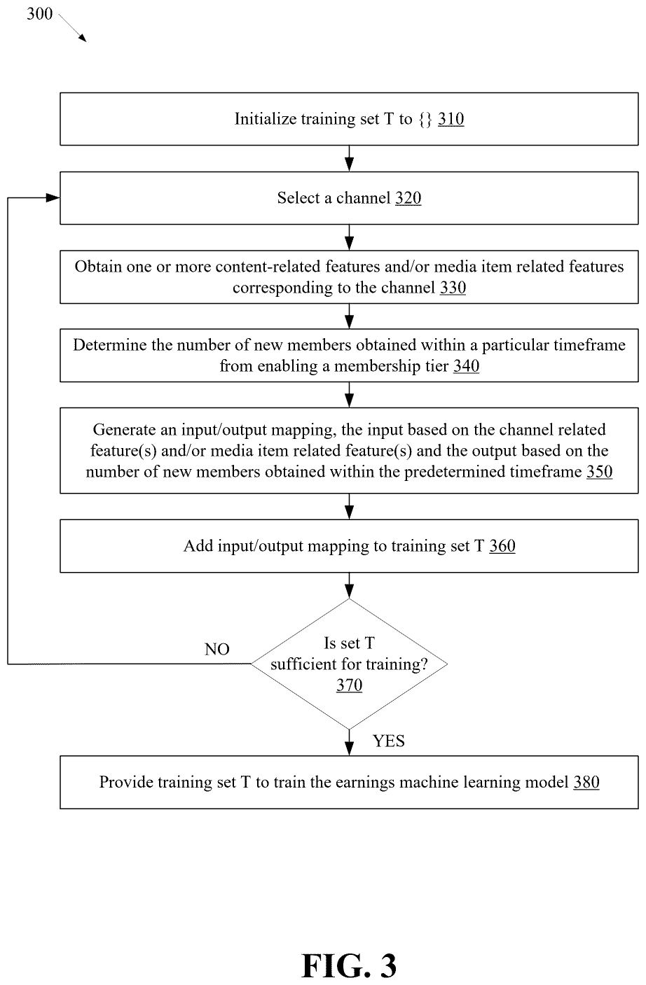

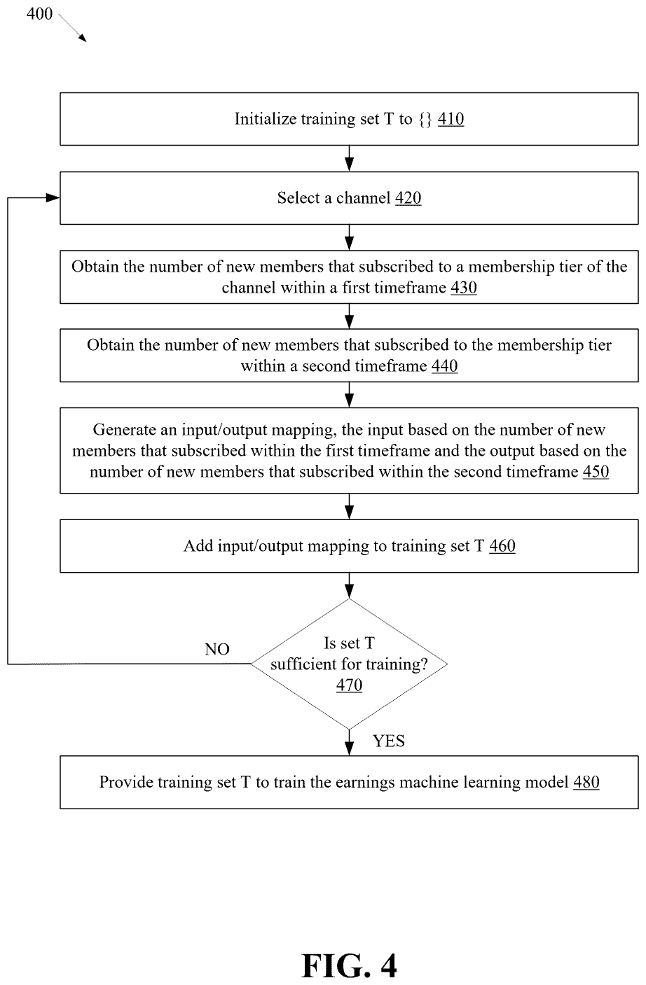

In some implementations, the channel features and/or media item features used by training data generator 131 can be from a particular timeframe (e.g., within the previous 30 days of enabling channel memberships, 6 months after enabling channel memberships, etc.). For example, the channel features and/or media item features used can include view activity data related to a media item from the previous 6 months, earnings data for the channel from the previous 30 days, particular engagement data from the previous 3 months, the number of new members that subscribed to a membership tier 30 days after the membership tier was offered, etc. implementing the training data is discussed in detail in FIGS. 3 and 4

Server machine 140 may include a training engine 141. Training engine 141 can train the earnings A I models 160A, 160B using the training data from training data generator 131. In some implementations, the earnings AI models 160A, 160B can be created by the training engine 141 using the training data that includes training inputs (e.g., certain channel feature(s) and/or certain media item features) and corresponding target outputs (correct answers for respective training inputs, such as the number of new members for a membership tier within a predetermined time frame). The training engine 141 can find patterns in the training data that map the training input to the target output (the answer to be predicted) and provide AI models 160A, 160B that captures these patterns. The AI models 160A, 160B can perform, e.g., a single level of linear or non-linear operations. An example of a deep network is a neural network with one or more hidden layers, and such an AI model can be trained by, for example, adjusting weights of a neural network in accordance with a backpropagation learning algorithm or the like. In other or similar implementations, the AI models 160A, 160B can refer to the model artifact that is created by training engine 141 using training data that includes training inputs. Training engine 141 can find patterns in the training data, identify clusters of data that correspond to the identified patterns, and provide the AI models 160A, 160B that captures these patterns. AI models 160A, 160B can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

Server machine 150 can include recommendation engine 151, which can be configured to utilize AI models 160A, 160B to generate prediction data for a particular channel. In particular, recommendation engine 151 can provide an identifier of the channel, as input, to AI models 160A, 160B. In some implementations, the recommendation engine 151 can obtain, as input to one or more AI models 160A, 160B, certain channel features related to the channel and/or certain media item features from one or more media items on the channel. Recommendation engine 151 can then obtain one or more outputs from AI models 160A, 160B, the one or more outputs reflecting one or more incentives recommendations 124, or used to generate one or more incentives recommendations 124. In particular, AI models 160A, 160B can provide one or more outputs that include data indicative of the number of new members a channel owner would obtain within a predetermined period of time after enabling channel memberships, a growth trajectory of new members based on the predicted number of new members, etc. In an illustrative example, the outputs can include a first value indicating a first number of projected members subscribing to a respective channel with an enabled set of membership tiers and a second value indicating a second number of projected members subscribing to the respective channel with the enabled set of membership tiers. The second value can reflect the second number of projected members during a first specified period of time and is based on the first number of projected members during a second specified period of time, where the second specified period of time precedes the first specified period of time. For example, AI model 160A can be used to predict the number (“first value”) of new members a channel owner would obtain within a predetermined timeframe after enabling channel memberships (e.g., during the second specified period of time such as 30 days after offering a membership tier) while AI model 160B can estimate an additional number of new members (“second value”) representing a growth trajectory of new members (e.g., during the first specified period of time such as 60 days after the second specified period of time and based on the predicted new members data obtained from the first AI model). In some implementations, recommendation engine 151 can store the predicted output data (e.g., incentives recommendation 124) on data store 110.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 3 depicts a flow diagram of an example method 300 for training an AI model to predict the number of new members a channel is projected to obtain within a predetermined timeframe after enabling channel memberships, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1 In some implementations, some or all of the operations of method 200 can be performed by training data generator 131 and/or training engine 141, as described above.

For simplicity of explanation, method 300, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 300 in accordance with the disclosed subject matter. In addition, those skilled in the art will understand and appreciate that method 300 could alternatively be represented as a series of interrelated states via a state diagram or events. Additionally, it should be appreciated that method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 310, processing logic initiates training set T to { } (e.g., to empty).

At operation 320, processing logic selects a channel. The channel can be a channel that has enabled a particular content-related feature, such as, for example, a membership tier for the channel. In some implementations, the channel selected can be a channel that had channel memberships enabled for a predetermined amount of time (e.g., enabled for 30 days, 60 days, etc.). In some implementations, the channel can be a channel that enabled the membership tier within a predetermined amount of time (e.g., enabled a membership tier less than a year prior, less than two years prior, etc.). In some implementations, the channel can be a currently active channel (e.g., a channel currently available on content sharing platform 120), an unavailable channel (e.g., a channel currently unavailable on content sharing platform 120, but data related to the channel, such as, channel features and/or media item features, is accessible from content sharing platform 120, from data store 110, etc.), etc.

At operation 330, processing logic obtains one or more channel features and/or one or more media item features corresponding to the channel. In some implementations, the channel feature(s) can be certain types of data (e.g., characteristics data, viewer activity data, engagement data, earnings data, monetization settings, activities data, etc.) related to the particular channel. The media item feature(s) can be certain types of data (e.g., characteristics data, viewer activity data, engagement data, earnings data, monetization settings, activities data, etc.) related to a media item on the particular channel. In some implementations, the channel features and/or media item features can be historical data (e.g., data previously obtained from content sharing platform 120 and stored on, for example, data store 110), can be current data, such as data obtained from a current channel, etc.

At operation 340, processing logic determines the number of new members obtained within a particular timeframe from enabling the membership tier. For example, processing logic can determine how many new members obtained access to the membership tier during a particular 30-day time frame after channel memberships to the membership tier were enabled.

At operation 350, processing logic generates an input/output mapping, the input based on the channel feature(s) and/or media item feature(s) and the output based on the number of new members obtained within the predetermined time frame.

At operation 360, processing logic adds the input/output mapping to training set T.

At operation 370, processing logic determines whether set T is sufficient for training. In response to processing logic determining that set T is not sufficient for training, method 300 can return to operation 320. The processing logic can then select another channel, select different or additional channel features and/or media item features for a previously selected channel, etc. In response to processing logic determining that set T is sufficient for training, method 300 can proceed to operation 380.

At operation 380, processing logic provides training set T to train an AI model, such as AI model 160A, as described above.

Once the processing logic provides the training set T to train the AI model, the Al model can be trained to generate, for a given channel, predictive data related to the number of new members a membership tier can expect to obtain in response to the channel offering the membership tier.

FIG. 4 depicts a flow diagram of an example method 400 for training an AI model to predict a growth trajectory of new members, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1 In some implementations, some or all of the operations of method 400 can be performed by training data generator 131 and/or training engine 141, as described above.

At operation 410, processing logic initiates training set T to { } (e.g., to empty).

At operation 420, processing logic selects a channel. The channel can be a channel that has enabled a particular content-related feature, such as, for example, a membership tier for the channel. In some implementations, the channel selected can be a channel that had channel memberships enabled for a predetermined amount of time (e.g., enabled for 180 days, 365 days, etc.). In some implementations, the channel can be a channel that enabled the membership tier within a predetermined amount of time (e.g., enabled a membership tier less than a year prior, less than two years prior, etc.). In some implementations, the channel can be a currently active channel (e.g., a channel currently available on content sharing platform 120), an unavailable channel (e.g., a channel currently unavailable on content sharing platform 120, but data related to the channel, such as, channel features and/or media item features, is accessible from content sharing platform 120, from data store 110, etc.), etc.

At operation 430, processing logic obtains the number of new members that subscribed to a membership tier of the channel within a first timeframe. For example, the processing logic can obtain the number of new members that subscribed to a membership tier within 30 days of the membership tier being made available.

At operation 440, processing logic obtains the number of new members that subscribed to the membership tier within a second timeframe. For example, the processing logic can obtain the number of new members that subscribed to the membership tier within one year of the membership tier being made available.

At operation 450, processing logic generates an input/output mapping, the input based on the number of new members that subscribed within the first timeframe and the output based on the number of new members that subscribed within the second timeframe.

At operation 460, processing logic adds the input/output mapping to training set T.

At operation 470, processing logic determines whether set T is sufficient for training. In response to processing logic determining that set T is not sufficient for training, method 400 can return to operation 420. The processing logic can then select another channel, select different or additional time period for a previously selected channel, etc. In response to processing logic determining that set T is sufficient for training, method 400 can proceed to operation 480.

At operation 480, processing logic provides training set T to train an AI model, such as AI model 160B, as described above.

Once the processing logic provides the training set T to train the AI model, the Al model can be trained to generate growth data related to the number of new members a channel can expect to obtain for a specific timeframe.

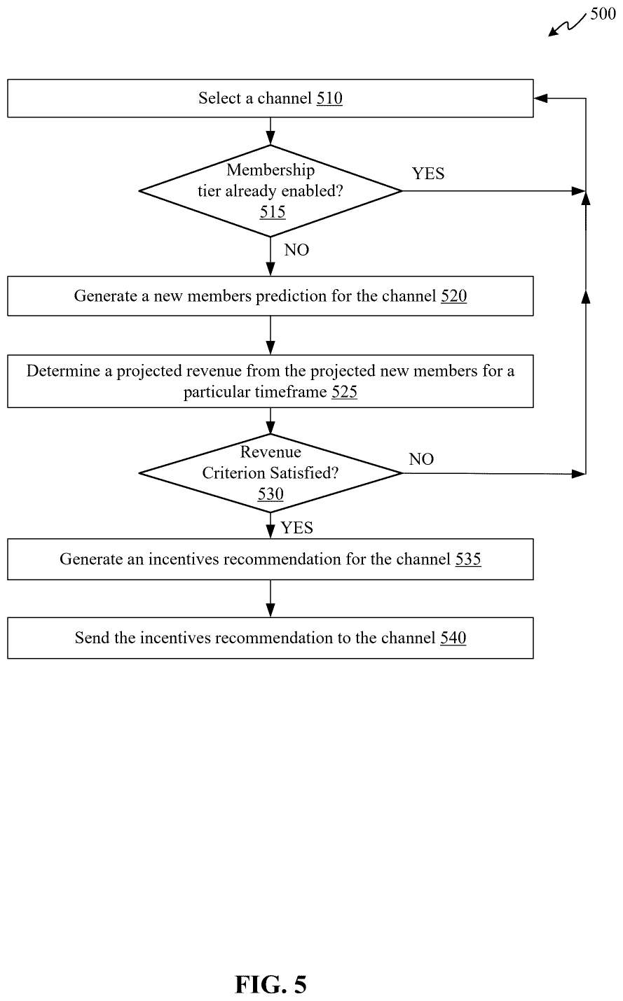

FIG. 5 depicts a flow diagram of an example method 500 for generating an incentives recommendation using AI model(s), in accordance with implementations of the present disclosure. Method 500 can be performed by processing logic that can include hardware (circuitry, dedicated logic, etc.), software (e.g., instructions run on a processing device), or a combination thereof. In one implementation, some or all of the operations of method 500 can be performed by one or more components of system 100 of FIG. 1 In some embodiments, some or all of the operations of method 500 can be performed by recommendation engine 151, as described above.

At operation 510, processing logic selects a channel. The channel can be selected at random, based on a predetermined criterion (e.g., age of the channel, geographic region of the channel, type of channel, etc.). In some implementations, one or more channel owners can first be identified and then one or more of their respective channels can be selected via operation 510. In such implementations, the operations of method 500 can be performed, for each channel and/or channel owner, individually or collectively.

At operation 515, processing logic determines whether the channel has already enabled a membership tier. Responsive to the processing logic determining that the channel already offers one or more membership tier(s) on the channel, the processing logic proceeds to operation 510 and selects another channel. Responsive to the processing logic determining that the channel does not offer a membership tier, the processing logic proceeds to operation 520.

At operation 520, processing logic generates new members prediction for the channel (for a certain timeframe). In particular, the processing logic obtains one or more channel features corresponding to the channel and/or one or more media item features corresponding to a media item(s) on the channel. Next, the processing logic provides an indication of the one or more channel features and/or media item features as input to an AI model. The AI model can be AI model 160A, an AI model that is configured to perform the functions of both AI model 160A and AI model 160B, etc. The AI model 160A can be trained via, for example, method 300 of FIG. 3. Next, the processing logic, via the trained AI model, generates a new members prediction for the channel. The new members prediction can indicate how many new members (e.g., subscribers) a membership tier can expect to receive, over a certain timeframe (e.g., a month from activation, six months from activation, a year from activation, etc.), by enabling the membership tier. In some implementations, the output from AI model 160A can be fed to another AI model (e.g., AI model 160B) to obtain a growth trajectory of new members for another certain timeframe (e.g., AI model 160A generates predictions for a month after activation and AI model 160B extrapolates the output to predict the number of new members a year after activation).

At operation 525, processing logic determines a projected revenue from the projected new members for a particular timeframe. In an example, the processing logic can multiply the number of projected new members by the cost of the channel per month by the number of months each new member is projected to access the membership tier.

At operation 530, processing logic determines whether the projected revenue satisfies a revenue criterion. For example, the revenue criterion can be a range of monetary values (e.g., between $4,000 and $5,000). In some implementations, multiple revenue criterion can be used, and the incentives recommendation selected in operation 535 can be related to which revenue criterion is satisfied. In some implementations, the revenue criterion can be a threshold value which is satisfied when the projected revenue is greater than the threshold value. Responsive to the processing logic determining that the projected revenue fails to satisfy the revenue criterion, the processing logic proceeds to operation 510 and selects another channel. Responsive to the processing logic determining that the projected revenue satisfies the revenue criterion, the processing logic proceeds to operation 535.

At operation 535, processing logic generates an incentives recommendation for the channel. For example, processing logic can determine, based on the output data, one or more personalized incentives (e.g., monetary values) for the channel, and generate an incentives recommendation that includes the personalized incentives. In some implementations, to generate one or more personalized incentives, processing logic can select the incentives that correspond to the range of the projected revenue. For example, responsive to determining that the projected revenue is between $4,000 and $5,000, the processing logic can select the corresponding incentives of $1,000 to launch and maintain the membership tier for at least one year, $10 per new member, and $2000 for obtaining 90 new members. In other implementations, the processing logic can generate the personalized incentives by inputting the projected revenue into an incentives model (e.g., a mathematical formula, another AI model, an algorithm, etc.), which would produce personalized incentives based on the projected revenue value.

At operation 540, processing logic sends the incentives recommendation to the channel owner. In some implementations, the incentives recommendation can be presented on the user interface associated with the channel, sent to an email address related to the channel owner, sent as a text to a phone number related to the channel owner, etc.

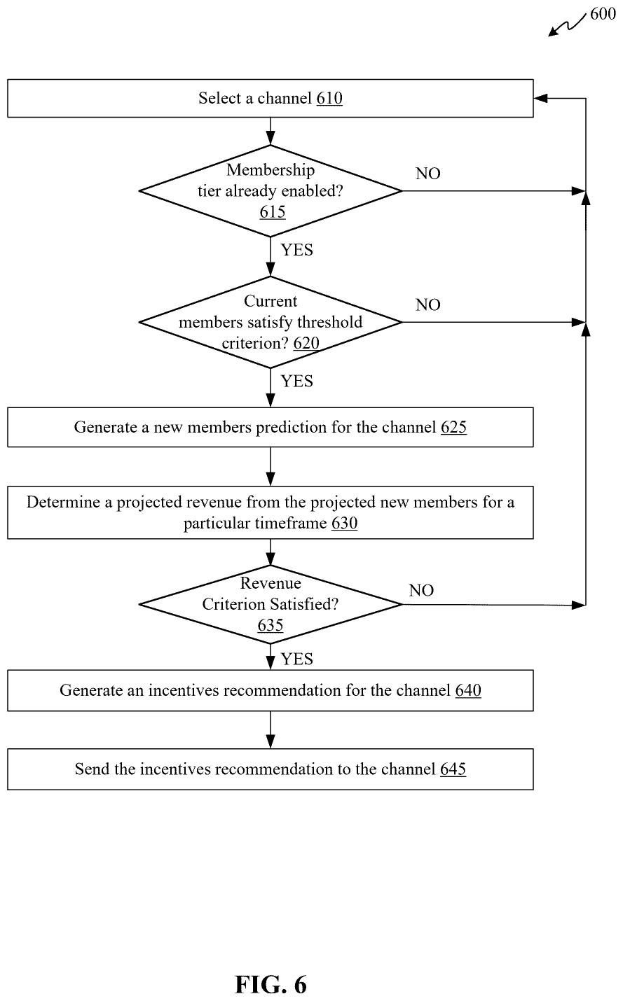

FIG. 6 depicts a flow diagram of an example method 600 for generating an incentives recommendation for a channel that already enabled a membership tier, in accordance with implementations of the present disclosure. Method 600 can be performed by processing logic that can include hardware (circuitry, dedicated logic, etc.), software (e.g., instructions run on a processing device), or a combination thereof. In one implementation, some or all of the operations of method 600 can be performed by one or more components of system 100 of FIG. 1 In some embodiments, some or all of the operations of method 600 can be performed by recommendation engine 151, as described above.

At operation 610, processing logic selects a channel. The channel can be selected at random, based on a predetermined criterion (e.g., age of the channel, geographic region of the channel, type of channel, etc.). In some implementations, one or more channel owners can first be identified and then one or more of their respective channels can be selected via operation 510. In such implementations, the operations of method 500 can be performed, for each channel and/or channel owner, individually or collectively.

At operation 615, processing logic determines whether the channel has already enabled a membership tier. Responsive to the processing logic determining that the channel does not offer a membership tier, the processing logic proceeds to operation 610 and selects another channel. Responsive to the processing logic determining that the channel already offers one or more membership tier(s) on the channel, the processing logic proceeds to operation 620.

At operation 620, processing logic determines whether the membership tier satisfies a current members threshold criterion. In some implementations, the current members threshold criterion can include a threshold value of subscribed members. Responsive to the processing logic determining that the membership tier fails to satisfy a current members threshold criterion (e.g., the current number of members is greater than a threshold value), the processing logic proceeds to operation 610 and selects another channel. Responsive to the processing logic determining that the membership tier satisfies a current members threshold criterion (e.g., the current number of members is below a threshold value), the processing logic proceeds to operation 625.

At operation 625, processing logic generates new members prediction for the channel (for a certain timeframe). In particular, the processing logic obtains one or more channel features corresponding to the channel and/or one or more media item features corresponding to a media item(s) on the channel. Next, the processing logic provides an indication of the one or more channel features and/or media item features as input to an AI model.

At operation 630, processing logic determines a projected revenue from the projected new members for a particular timeframe. In an example, the processing logic can multiply the number of projected new members by the cost of the channel per month by the number of months each new member is projected to access the membership tier.

At operation 635, processing logic determines whether the projected revenue satisfies a revenue criterion. Responsive to the processing logic determining that the projected revenue fails to satisfy the revenue criterion, the processing logic proceeds to operation 610 and selects another channel. Responsive to the processing logic determining that the projected revenue satisfies the revenue criterion, the processing logic proceeds to operation 640.

At operation 640, processing logic generates an incentives recommendation for the channel. For example, processing logic can determine, based on the output data, one or more personalized incentives (e.g., monetary values) for the channel, and generate an incentives recommendation that includes the personalized incentives. Since the membership tier is already enabled, the personalized incentives can be related to actions (e.g., conditions) that require the channel owner to promote the membership tier (e.g., uploading a members-only media item (e.g., video item), providing a members-only livestream, chatting in the livestream, generating a members-only post, adding a special award (e.g., badge, emoji, icon, avatar, etc.), referencing the membership tier during in a media item (e.g., in a video item), etc. In some implementations, to generate one or more personalized incentives, processing logic can select the incentives that correspond to the range of the projected revenue. For example, responsive to determining that the projected revenue is between $4,000 and $5,000, the processing logic can select the corresponding incentives of $50 to upload a members-only media item, $10 per new member, and $2000 for obtaining 90 new members. In other implementations, the processing logic can generate the personalized incentives by inputting the projected revenue into an incentives model (e.g., a mathematical formula, another AI model, an algorithm, etc.), which would produce personalized incentives based on the projected revenue value.

At operation 645, processing logic sends the incentives recommendation to the channel owner. In some implementations, the incentives recommendation can be presented on the user interface associated with the channel, sent to an email address related to the channel owner, sent as a text to a phone number related to the channel owner, etc.

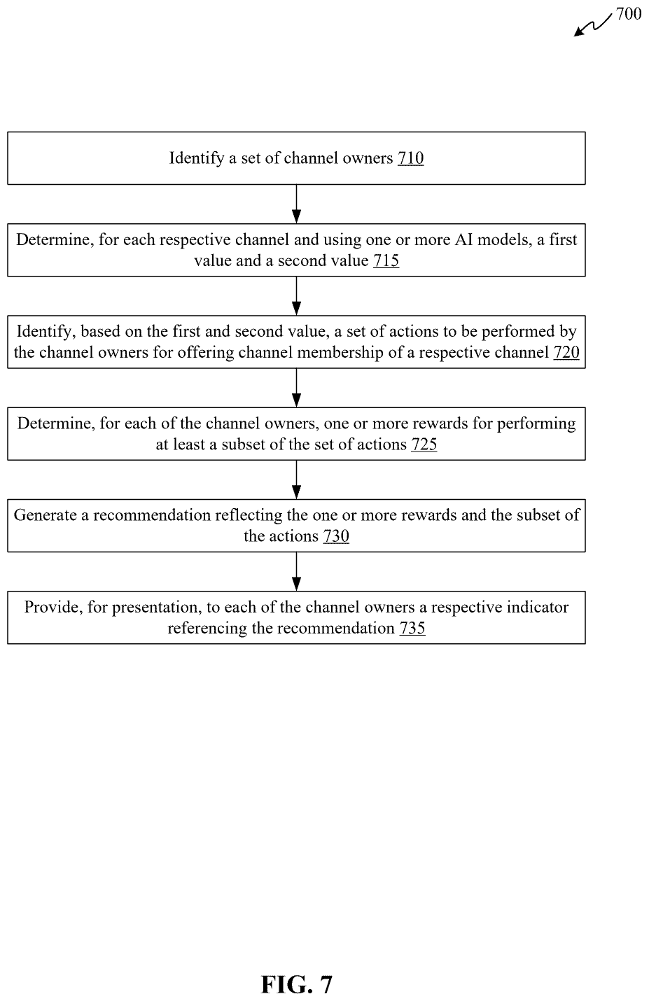

FIG. 7 depicts a flow diagram of another example method 700 for generating an incentives recommendation for a channel, in accordance with implementations of the present disclosure. Method 700 can be performed by processing logic that can include hardware (circuitry, dedicated logic, etc.), software (e.g., instructions run on a processing device), or a combination thereof. In one implementation, some or all of the operations of method 700 can be performed by one or more components of system 100 of FIG. 1 In some embodiments, some or all of the operations of method 700 can be performed by recommendation engine 151, as described above.

At operation 710, processing logic identifies a set of channel owners. Each channel owner can be an administrator of a respective channel of a content sharing platform.

At operation 715, processing logic determining, for each respective channel and using one or more AI models, a first value indicating a first number of projected members subscribing to a respective channel with an enabled set of membership tiers and a second value indicating a second number of projected members subscribing to the respective channel with the enabled set of membership tiers. The second value can reflect the second number of projected members during a first specified period of time and is based on the first number of projected members during a second specified period of time, where the second specified period of time precedes the first specified period of time. For example, a first AI model can be used to predict the number (“first value”) of new members a channel owner would obtain within a predetermined timeframe after enabling channel memberships (e.g., during the second specified period of time such as 30 days after offering a membership tier) while a second AI model can estimate an additional number of new members (“second value”) representing a growth trajectory of new members (e.g., during the first specified period of time such as 60 days after the second specified period of time and based on the predicted new members data obtained from the first AI model).

At operation 720, processing logic identifies, for each respective channel, and based on the respective first value and the respective second value, a set of actions to be performed by the channel owners for offering channel membership of a respective channel. For example, the actions can include launching a channel membership, obtaining a new member for the channel membership, maintaining the channel membership for a predetermined period of time, uploading a members-only media item (e.g., video item), providing a members-only livestream, chatting in the livestream, generating a members-only post, adding a special award (e.g., badge, emoji, icon, avatar, etc.), referencing the channel membership during in a media item (e.g., in a video item), etc.

At operation 725, processing logic determines, for each of the channel owners, one or more rewards for performing at least a subset of the set of actions. The rewards can be determined based on, for example, a revenue criterion determined using output from an artificial intelligence (AI) model. In some implementations, the rewards can be based on a projected revenue (determined based on the first and/or second values from the AI model output) of the content sharing platform derived from a number of members projected to subscribe to the content offered by one of the respective channels.

At operation 730, processing logic generates a recommendation reflecting the one or more rewards and the subset of the action (e.g., $1000 to launch a membership tier, $50 to upload a members-only media item, $10 per new member, $2000 for obtaining 90 new members, etc.).

At operation 735, processing logic provides, for presentation to each of the channel owners, a respective indicator referencing the recommendation. In some implementations, the indicator can be an incentives recommendation presented on the user interface associated with each respective channel, sent to an email address related to the channel owner, sent as a text to a phone number related to the channel owner, etc.

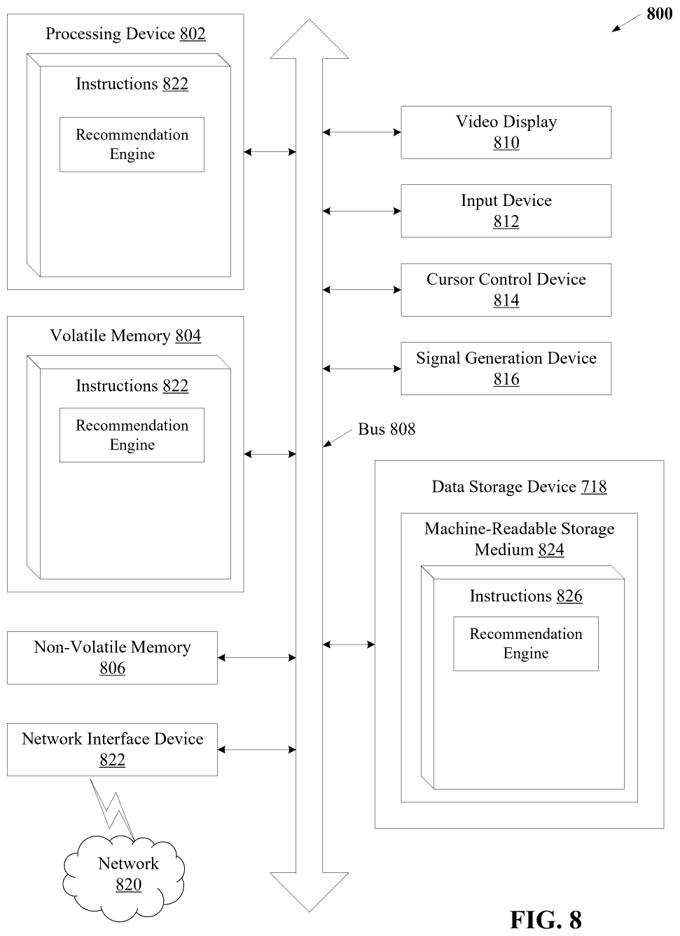

FIG. 8 depicts a block diagram of a computer system operating in accordance with one or more aspects of the present disclosure. In certain implementations, computer system 800 can be connected (e.g., via a network, such as a Local Area Network (LAN), an intranet, an extranet, or the Internet) to other computer systems. Computer system 800 can operate in the capacity of a client device. Computer system 800 can operate in the capacity of a server or a client computer in a client-server environment. Computer system 800 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 can include a processing device 802, a volatile memory 804 (e.g., random access memory (RAM)), a non-volatile memory 806 (e.g., read-only memory (ROM) or electrically erasable programmable ROM (EEPROM)), and a data storage device 818, which can communicate with each other via a bus 808.

Processing device 802 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 can further include a network interface device 822. Computer system 800 also can include a video display unit 810 (e.g., an LCD), an input device 812 (e.g., a keyboard, an alphanumeric keyboard, a motion sensing input device, touch screen), a cursor control device 814 (e.g., a mouse), and a signal generation device 816.

Data storage device 818 can include a non-transitory machine-readable storage medium 824 on which can store instructions 826 encoding any one or more of the methods or functions described herein, including instructions encoding components of client device of FIG. 1 for implementing methods 300, 400, 500, 600, and 700.

Instructions 826 can also reside, completely or partially, within volatile memory 804 and/or within processing device 802 during execution thereof by computer system 800, hence, volatile memory 804 and processing device 802 can also constitute machine-readable storage media.

While machine-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 300 and 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a processing device of a content sharing platform, a plurality of channel owners, each channel owner associated with a respective channel of a set of channels of the content sharing platform;
determining, for each respective channel using one or more artificial intelligence (AI) models, a first value indicating a first number of projected members subscribing to a respective channel with an enabled set of membership tiers and a second value indicating a second number of projected members subscribing to the respective channel with the enabled set of membership tiers;
for each respective channel, identifying, based on the respective first value and the respective second value, a set of actions to be performed by the respective channel owner of the plurality of channel owners for enabling the set of membership tiers;
determining, for each channel owner of the plurality of channel owners, one or more rewards for performing at least a subset of the set of actions;
generating a recommendation reflecting the one or more rewards and the subset of the actions; and
providing, for presentation to each of the plurality of channel owners, a respective indicator referencing the recommendation.

2. The method of claim 1, wherein the second value reflects the second number of projected members during a first specified period of time and is based on the first number of projected members during a second specified period of time, wherein the second specified period of time precedes the first specified period of time.

3. The method of claim 1, wherein input to the one or more AI models reflects at least one of: viewer interactions with at least one of the respective channel or a media item on the respective channel, activities performed by the respective channel owner on at least one of the respective channel or on a media item on the respective channel, or metrics associated with at least one of the respective channel or a media item on the respective channel.

4. The method of claim 1, wherein the indicator is at least one of a pop-up message on a user interface associated with the channel, an email message, or a text message.

5. The method of claim 1, further comprising:
determining, based on at least one of the first value or the second value, a projected revenue of the content sharing platform derived from a number of members projected to subscribe to the content offered by one of the respective channels, wherein the determined one or more rewards are based on the projected revenue.

6. The method of claim 5, wherein the one or more respective actions includes at least one of enabling the content, subscribing a new member to the content, or obtaining a certain number of new members to the content by a certain date.

7. The method of claim 1, wherein the first number of projected members is determined by a first AI model of the one or more AI models and the second number of projected members is determined by a second AI model of the one or more AI models.

8. A system comprising:
a memory; and
a processing device, coupled to the memory, the processing device to perform operations comprising:
identifying a plurality of channel owners, each channel owner associated with a respective channel of a set of channels of a content sharing platform;
determining, for each respective channel using one or more artificial intelligence (AI) models, a first value indicating a first number of projected members subscribing to a respective channel with an enabled set of membership tiers and a second value indicating a second number of projected members subscribing to the respective channel with the enabled set of membership tiers;
for each respective channel, identifying, based on the respective first value and the respective second value, a set of actions to be performed by the respective channel owner of the plurality of channel owners for enabling the set of membership tiers;
determining, for each channel owner of the plurality of channel owners, one or more rewards for performing at least a subset of the set of actions;
generating a recommendation reflecting the one or more rewards and the subset of the actions; and
providing, for presentation to each of the plurality of channel owners, a respective indicator referencing the recommendation.

9. The system of claim 8, wherein the second value reflects the second number of projected members during a first specified period of time and is based on the first number of projected members during a second specified period of time, wherein the second specified period of time precedes the first specified period of time.

10. The system of claim 8, wherein input to the one or more AI models reflects at least one of: viewer interactions with at least one of the respective channel or a media item on the respective channel, activities performed by the respective channel owner on at least one of the respective channel or on a media item on the respective channel, or metrics associated with at least one of the respective channel or a media item on the respective channel.

11. The system of claim 8, wherein the indicator is at least one of a pop-up message on a user interface associated with the channel, an email message, or a text message.

12. The system of claim 8, wherein the operations further comprise:
determining, based on at least one of the first value or the second value, a projected revenue of the content sharing platform derived from a number of members projected to subscribe to the content offered by one of the respective channels, wherein the determined one or more rewards are based on the projected revenue.

13. The system of claim 12, wherein the one or more respective actions includes at least one of enabling the content, subscribing a new member to the content, or obtaining a certain number of new members to the content by a certain date.

14. The system of claim 8, wherein the first number of projected members is determined by a first AI model of the one or more AI models and the second number of projected members is determined by a second AI model of the one or more AI models.

15. A non-transitory computer-readable medium comprising instructions that, responsive to execution by a processing device, cause the processing device to perform operations comprising:
identifying a plurality of channel owners, each channel owner associated with a respective channel of a set of channels of a content sharing platform;
determining, for each respective channel using one or more artificial intelligence (AI) models, a first value indicating a first number of projected members subscribing to a respective channel with an enabled set of membership tiers and a second value indicating a second number of projected members subscribing to the respective channel with the enabled set of membership tiers;
for each respective channel, identifying, based on the respective first value and the respective second value, a set of actions to be performed by the respective channel owner of the plurality of channel owners for enabling the set of membership tiers;
determining, for each channel owner of the plurality of channel owners, one or more rewards for performing at least a subset of the set of actions;
generating a recommendation reflecting the one or more rewards and the subset of the actions; and
providing, for presentation to each of the plurality of channel owners, a respective indicator referencing the recommendation.

16. The non-transitory computer readable storage medium of claim 15, wherein the second value reflects the second number of projected members during a first specified period of time and is based on the first number of projected members during a second specified period of time, wherein the second specified period of time precedes the first specified period of time.

17. The non-transitory computer readable storage medium of claim 15, wherein input to the one or more AI models reflects at least one of: viewer interactions with at least one of the respective channel or a media item on the respective channel, activities performed by the respective channel owner on at least one of the respective channel or on a media item on the respective channel, or metrics associated with at least one of the respective channel or a media item on the respective channel.

18. The non-transitory computer readable storage medium of claim 15, wherein the indicator is at least one of a pop-up message on a user interface associated with the channel, an email message, or a text message.

19. The non-transitory computer readable storage medium of claim 15, wherein the operations further comprise:
determining, based on at least one of the first value or the second value, a projected revenue of the content sharing platform derived from a number of members projected to subscribe to the content offered by one of the respective channels, wherein the determined one or more rewards are based on the projected revenue.

20. The non-transitory computer readable storage medium of claim 19, wherein the one or more respective actions includes at least one of enabling the content, subscribing a new member to the content, or obtaining a certain number of new members to the content by a certain date.
